(19) United States
(12) Patent Application Publication
(10) Pub. No.: US 2002/0029935 A1
(43) Pub. Date: Mar. 14, 2002

(54) ELEVATOR, PARTICULARLY A TRACTION SHEAVE ELEVATOR

(76) Inventors: GUNTER REUTER, FILDERSTADT (DE); HANS FERDINAND FRHR. V. SCHOLLEY, WOLFSCHLUGEN (DE); HANS UNTERGASSER, NEUHAUSEN (DE); JURGEN SCHULZ, METZINGEN (DE); GUNTHER BLICKLE, AICHTAL (DE); HARTMUT WEINMANN, FILDERSTADT (DE)

Correspondence Address: SHLESINGER ARKWRIGHT & GARVEY, 3000 SOUTH EADS STREET, ARLINGTON, VA, 22202

(21) Appl. No.: 09/181,334

(22) Filed: Oct. 28, 1998

(30) Foreign Application Priority Data
Nov. 28, 1997 (EP) 97120908.5

(51) Int. Cl. B66B 11/08

(52) U.S. Cl. 187/254

(57) ABSTRACT

An elevator with an elevator cage guided in a shaft between a shaft head and a shaft pit, having an elevator cage roof and an elevator cage base and a drive, which is connected by at least one hauling cable with the elevator cage, whereby in particular for performing maintenance work the elevator cage roof is designed to be accessible, whereby the drive is arranged at least partly in the shaft head over a first region of the elevator cage roof and the accessibility of the elevator cage roof is restricted to a second region.

### THE FIELD OF THE INVENTION

The present invention relates to an elevator, in particular a traction sheave elevator.

### BACKGROUND OF THE INVENTION

Usually elevators with traction sheave drive have an elevator cage arranged in an elevator shaft and on the top a driving mechanism area, in which the control, driving mechanism and other elevator components are arranged. Here the cables of one traction sheave side run down to the elevator cage and of the other side to the counterbalance. So that maintenance staff can also stand on the elevator cage roof even during elevator operation to perform maintenance or installation work, for this propose a minimum safety area above the elevator cage roof is necessary which extends from the elevator cage roof in the upper elevator cage position to the lower edge of the components arranged above or up to the shaft ceiling. In general with such elevators with a driving mechanism area outside the shaft in the shaft head at least roller supports for the return pulleys of the hauling cables are arranged, which can also be arranged next to the shaft surface loaded by the elevator cage.

With elevators with a driving mechanism in the shaft the drive can be arranged in the top or bottom part of the elevator shaft between the region used by the elevator cage during its operation and a wall of the elevator shaft. The disadvantage here is that because of the arrangement of the drive in the elevator shaft the total cross sectional area of the elevator shaft cannot be used for the elevator cage. The larger size of the elevator shaft necessary for a specific elevator cage results in higher overall costs for the elevator or a reduction in building space. A further disadvantage is that the drive with a large elevator cage cannot exceed a specific size, without the need for recesses for example in the shaft wall.

To avoid such difficulties it is proposed in EP 0 646 537 A1 to design the elevator with a driving mechanism area above the elevator shaft, in which the drive is arranged. Such constructions result in an additional construction height of the elevator above the elevator cage track, so that either the entire shaft cannot be used for elevator operation or for example additional space has to be provided on the roof of a building. These measures are also associated with increased costs.

It is also known from EP _{0 646 537} A1 to arrange the drive and additional elevator components on a machine frame inserted into the elevator shaft. Such an arrangement according to the prior art is explained in detail in the description of the Figures. This structure however results in an increase of the shaft height over the shaft length used by the elevator cage, as the machine frame and the drive respectively require additional shaft height.

It is also desirable to design the roof of a elevator cage to be accessible even when the elevator is running, so that for example the installer can stand on the elevator cage roof to perform maintenance work. For safety reasons it is necessary to have a specific minimum distance as protection for the installer between the elevator cage roof and the components or the shaft roof arranged thereon, whereby the operation of the elevator is delimited upwards.

### OBJECTS AND SUMMARY OF THE INVENTION

The objective of the present invention is therefore to provide an elevator with an elevator drive of usual size arranged in the elevator shaft, without increasing the shaft head height compared to elevators with a driving mechanism sheave space outside the elevator shaft. In particular, by reducing construction costs the total cost of the elevator should be reducible.

By means of the solution according to the present invention it is possible to arrange the drive in the elevator shaft immediately above the elevator cage, without increasing the necessary height of the elevator shaft. By restricting the accessibility of the roof of the elevator cage to a specific area it is possible, whilst ensuring a prescribed safety distance between the elevator cage roof and ceiling of the elevator shaft only in this accessible region, to drive the elevator cage up to the minimal distance defined by the safety distance between the elevator cage roof and ceiling of the shaft. As in known elevator systems with a drive arranged in the shaft above the elevator cage the minimum distance between the lower edge of the drive and ceiling of the elevator cage had to be maintained, the shaft head height can be reduced considerably according to the invention with the same operation of the elevator cage. In addition the drive can be much greater in volume and therefore more efficient than a narrow drive applied only between the elevator cage and the shaft wall. The advantages of the invention are achieved in the same way with a drive arranged in the shaft pit, if the accessibility of the shaft pit is restricted accordingly.

According to a preferred embodiment of the invention the elevator cage can be driven in the shaft normally as in an elevator with a driving mechanism area outside the shaft, whereby a prespecified safety area between the elevator cage roof and the ceiling of the shaft is ensured in the second region of the elevator cage roof. Here the required height of the shaft is not higher than conventional elevators with driving mechanism area above the shaft. By means of a corresponding arrangement of the drive and the accessible region of the elevator cage roof, the required safety distance or safety area between the elevator cage roof and the shaft ceiling can be maintained in the accessible area.

According to a preferred embodiment the drive comprises a motor, a traction sheave for an elevator with counterbalance or a drum for an elevator without counterbalance and at least one return pulley. The present invention can also be used advantageously, if instead of the whole drive only one or more return pulleys are arranged above the elevator cage on roller carriers. It is possible for example to design the elevator with a lower adjacent engine, and to arrange only the at least one return pulley above the first region of the elevator cage roof. The region of the elevator cage roof below the return pulley is in this case not accessible.

Preferably the drive together with additional elevator components, in particular cable end suspensions and a speed restrictor are housed in a machine frame, which is supported by the shaft walls, by guiding rails of the elevator or by the shaft ceiling. Here in an advantageous manner the individual elements of the drive can be premounted in the machine frame, so that the thus installed drive can be inserted with the machine frame like a module into the elevator shaft. By these means the installation work at a building site can be reduced in an effective manner.

Advantageously the first region of the elevator cage roof is not accessible by means of using mechanical and/or electric locking means. It is ensured in this way that the drive cannot be switched on or switched off, when maintenance staff step onto the blocked off region of the elevator cage roof.

It is particularly preferable that on the first region of the elevator cage roof pressure mats and/or infrared radiation lattices or movement sensors are arranged, which are activated in particular by stepping into the first region and prevent the movement or further movement of the elevator cage.

Preferably in the region of the elevator cage roof a trigger device for an elevator operation restriction for a counterbalance of the elevator is arranged. Such a trigger device can be triggered as necessary, e.g. by stepping onto the blocked surface. In this way the safety of maintenance staff is increased further.

The present invention also results in a reduction in shaft height compared to conventional elevators. By arranging the drive at the level of the holder, the entire height of the mount and assembly group comprising the drive can be reduced compared to usual constructions. It is also possible in this way, with the same movement of the elevator cage to reduce the shaft height compared to the prior art and/or if necessary to increase the drive.

According to a preferred embodiment the mount in the shaft head is arranged above a first region of the elevator cage roof, and the second region of the elevator cage roof next to the first region ensures the prescribed safety distance above the elevator cage between the elevator cage roof and shaft ceiling, whereby the elevator cage roof is designed to be accessible and accessibility is restricted to the second region. This design is mainly a combination of both solutions according to the invention and permits an optimal use of the elevator shaft.

According to an additional preferred embodiment the mount is formed by a machine frame which surrounds the drive essentially laterally. In this way a particularly space-saving mount of the drive is ensured, which is secured in a simple manner in the shaft. In addition the drive in the space larger than in previous solutions of drives in the shaft can be designed to be larger and more effective.

Preferably the drive can be installed from below or above between the support of the machine frame and secured in a desired position. It is possible in this way to preinstall the drive in the machine frame, so that the entire assembly can be inserted into a elevator shaft as a module.

According to a preferred embodiment of the invention a support of the machine frame is designed to be rotatable or detachable so that after inserting the drive into the machine frame it can be moved into its bearing position. In this way assembly costs can be further reduced.

According to a preferred embodiment the machine frame and/or the drive arranged in the machine frame are arranged horizontally obliquely with respect to the shaft walls. In this way it is possible to ensure a direct connection between a counterbalance and the elevator cage suitable for the hauling cable.

Advantageously, the machine frame comprises recesses, in which supporting regions of the drive engage and/or bearing parts which project in the direction of the drive and engage around or in bearing drive parts. By such means the positioning or adjustment of the drive inside the machine frame is possible in a simple manner.

Preferably in addition return pulleys, cable suspensions and/or speed restrictors of the elevator can be attached to the machine frame. By installing these components in their intended places a preinstallation of these components is possible so that the assembly costs or adjustment costs on site are reduced.

Preferably the machine frame comprises additional installation aids, in particular fastening rings for the attachment of hoisting gear and/or return pulleys for cables, which are used for hoisting up guiding rails in a scaffold-free assembly of the elevator. A suspension for a control box of the drive arranged in the shaft can be attached to the frame as additional assembly means.

According to a preferred embodiment the drive is mounted in the frame by means of two suspension plates, each of which has a perpendicular plate region for the horizontal screwing on of the drive and a horizontal plate region for the insulated support on or in the frame. By using such suspension plates the assembly and precise positioning of the drive in the machine frame is possible in a simple manner.

It is also preferred that the machine frame is secured in shaft wall niches or in front of the shaft wall, on guiding rails or on the shaft ceiling.

In summary, the present invention is directed to an elevator with an elevator cage (16) guided in a shaft (14) between a shaft head and a shaft pit, having an elevator cage roof (17) and an elevator cage base and a drive (30), which is connected by at least one hauling cable with the elevator cage (16), whereby in particular for performing maintenance work the elevator cage roof (17) is designed to be accessible, whereby the drive is arranged at least partly in the shaft head over a first region (17a) of the elevator cage roof (17) and the accessibility of the elevator cage roof (17) is restricted to a second region (17b).

### BRIEF DESCRIPTION OF THE DRAWINGS

The invention is illustrated by way of an embodiment in the drawing and is described in detail in the following with reference to the drawing:

FIG. 1 shows a schematic side cross section of an elevator according to the invention along line I-I of FIG. 2;

FIG. 2 shows a schematic plan view of the elevator of FIG. 1;

FIG. 3 shows a side schematic cross-section of an elevator according to the prior art; and

FIG. 4 is an additional schematic side cross section showing further details of the invention of the elevator of the invention according to FIG. 1.

### BRIEF DESCRIPTION OF THE PREFERRED EMBODIMENTS

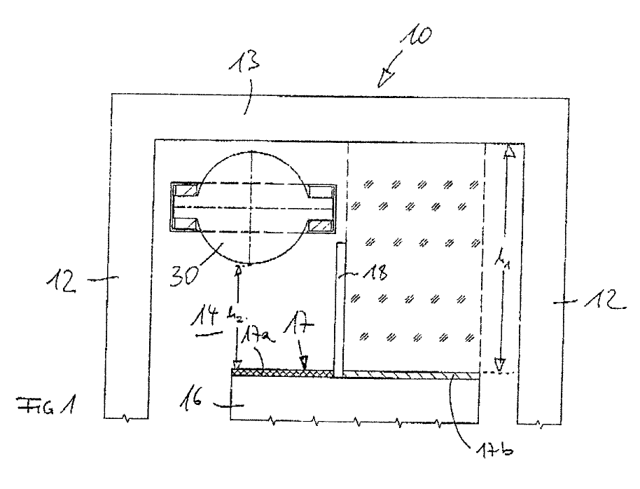

FIG. 1 shows in a schematic view a cross section of the top section of an elevator 10 according to the invention. The elevator 10 comprises an elevator cage 16 arranged in an elevator shaft 14 with an elevator cage roof 17. In the drawing of FIG. 1 the elevator cage 16 is in its upper stop position and only its roof section is shown.

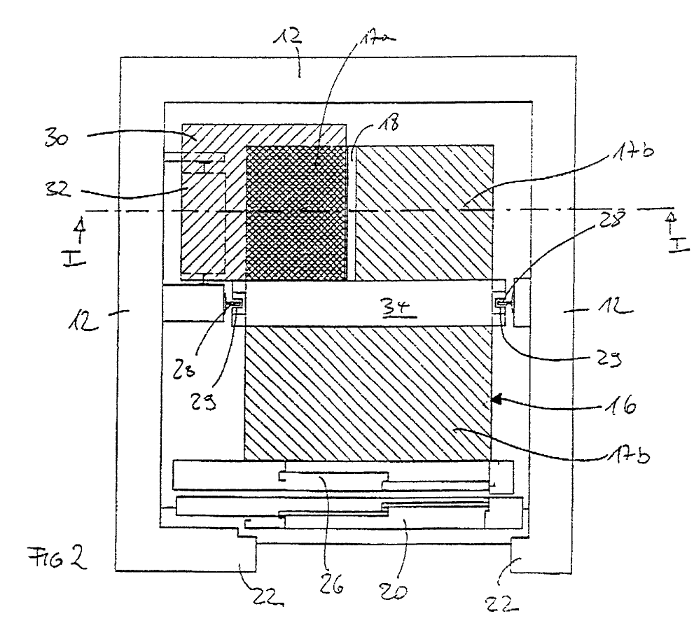

The elevator shaft 14 of the elevator 10 is delimited by shaft walls 12 and a shaft ceiling 13. On the elevator landing in the shaft wall 12 a door opening delimited by a reveal 22 is provided, which is closed by means of a shaft door 20 (cf. FIG. 2). An elevator cage door 26 is assigned to the elevator cage 16 which to open the passage between the elevator cage 16 and the elevator landing can be opened together with the shaft door 20.

In the elevator shaft 14 a drive for the elevator cage 16 is arranged for its vertical movement in the elevator shaft 14. The drive comprises a drive machine 30 which is arranged in the shaft head above the elevator cage 16. Additional elements of the drive, in particular a traction sheave and hauling cable for connecting the drive machine 30 with the elevator cage 16 are not illustrated in more detail for reasons of clarity.

As shown in FIG. 2 the elevator cage 16 is guided for the vertical movement in the elevator shaft 14 along guiding rails 28, which engage in guides 29 arranged in a support frame 34 of the elevator cage 16. The elevator cage 16 also acts in a known manner via the not shown hauling cables with a counterbalance 32. Instead of with a traction sheave the drive can also be equipped with a cable drum. Then the elevator can also function without a counterbalance.

Between the elevator cage roof 17 and the shaft ceiling 13 a height h1 is provided, which corresponds with the necessary and prescribed safety distance. By the arrangement of the drive machine in the shaft head the height is restricted in sections to the height h2 so that in a region 17a of the elevator cage roof 17 the safety distance is not ensured. To delimit the region 17b of the elevator cage roof 17 with the safety height h1 a railing 18 is provided, which delimits the safety area assigned to the region 17b from the region 17a of lower height. By means of the railing 18 the maintenance staff are prevented from entering region 17a of the elevator cage roof 17 when the elevator is moving. The access of the maintenance staff personal is thus restricted to the region 17b.

Preferably in addition to or alternatively to the railing 18 electronic safety devices are provided. These can be pressure mats or pressure elements or other electric safety means arranged in the region 17a, which when this region 17a is entered emit optical and/or acoustic signals which demand that this region be exited and/or prevent the movement of the elevator cage 16. As means for securing or delimiting the elevator cage roof sections 17a and 17b for example nets or warning signs or obliquely designed roof surfaces can be used.

With the elevator according to the invention despite the arrangement of the drive machine 30 inside the elevator shaft 14 immediately above the elevator cage 16 it is ensured that enough surfaces or regions 17b of the elevator cage roof 17 are freely accessible whilst adhering to the safety requirements for the maintenance staff.

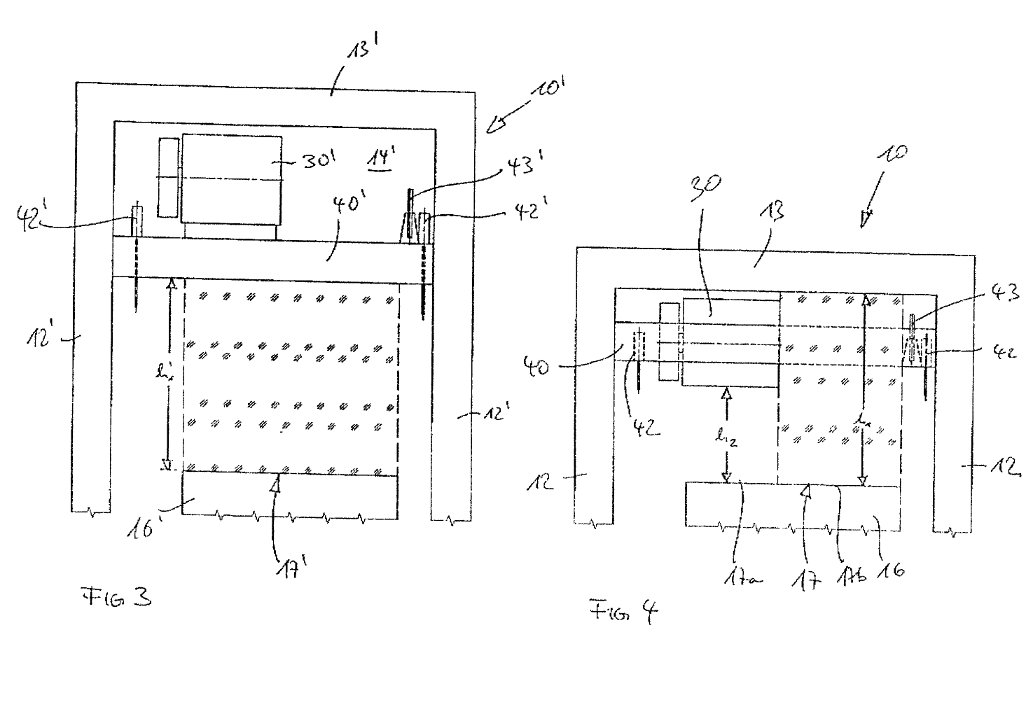

FIG. 3 shows in schematic cross section a shaft head of an elevator 10′ according to the prior art. In the elevator shaft 14′ of the known elevator 10′ delimited by shaft walls 12′ and a shaft ceiling 13′ a machine frame 40′ is attached to the shaft walls 12′, on which a drive comprising a drive machine 30′ is arranged. On the machine frame 40′ in addition cable suspensions 42′ and a speed restrictor 43′ are secured. In order to support the drive and the additional functional elements for operating the elevator the machine frame 40′ is spaced apart from the shaft ceiling 13′ sufficiently that the drive machine 30′ fits easily between the machine frame 40′ and the shaft ceiling 13′. In order to ensure a sufficient safety area for maintenance staff working on the elevator cage roof 17′ of the elevator cage 16′, the machine frame 40′ is arranged at a distance h′1, above the elevator cage roof 17′ of the elevator cage 16′ in its highest position.

In comparison with this the drawing of FIG. 4 on the same scale shows an elevator 10 according to the invention, in which the machine frame 40 surrounds the drive machine 30, the cable suspensions 42 and the speed restrictor 43, so that these components are “immersed” in the machine frame 40. In addition, the control box can also be arranged in or on the machine frame 40.

By these means according to the invention and by locking the elevator cage roof under the drive the shaft ceiling 13 can be lowered relative to the known elevator shown in FIG. 3 until the distance between the shaft ceiling 13 and the elevator cage roof 17 in the upper holding position of the elevator cage 16 corresponds to the height h1, whereby h1=h′1. Between the drive machine 30 immersed in the machine frame 40 of the elevator cage roof 17 and the elevator cage 16 in its highest position remains the height h2 already described in connection with FIG. 1, which is assigned to a non accessible region 17a of the elevator cage roof 17.

As further components that can be inserted into the machine frame reference is made for example to vertical teaching for aligning guiding rails and shaft doors. By the arrangement or positioning of the corresponding components on the machine frame the latter can also be used in an advantageous manner as a tolerance gauge.

The alignment and/or fastening of the known components such as e.g. rails, doors, control box on or in the machine frame 40 is preferably performed by means of installation aids or hooks on the machine frame 40.

Here it is preferable to mount the drive machine of the drive 30 by means of two suspension plates on the machine frame, which respectively have a perpendicular plate region for the horizontal attachment of the machine and a horizontal plate region for insulated support in the machine frame 40.

According to FIG. 1 the drive is provided with projections and the machine frame with recesses. This can however also be vice versa. Particularly preferable are C- or U-shaped regions of the machine frame, which surround specific regions of the drive. Also the drive housing itself in its outer region can be designed as a machine frame with bearing elements.

In addition additional components arranged underneath the machine frame in the shaft can be suspended for installation on hooks arranged on the frame over its installation place and can be easily finally secured, e.g. the control box or the guiding rails for the elevator cage and/or counterbalance.

Compared to known elevators without a driving mechanism area in which to maintain a safety area above the elevator cage roof a very flat drive machine is arranged laterally next to the elevator cage course in the shaft or in a corresponding shaft niche, the present invention permits the full use of the shaft cross section and the use of a conventional drive machine without omitting an accessible safety area on the elevator cage roof. By means of the design according the invention with a mount, which is arranged essentially at the same height as the mounted drive elements, a particularly simple and space saving arrangement of the drive in the shaft head is achieved. The mount according to the invention is not restricted to a rectangular machine mount surrounding the drive and additional functional parts, but can also comprise two or more brace elements of a combined, angled, in particular U-shaped bearing element.

Particularly advantageous is the possibility of using the mount according to the invention with for example the drive machine and additional functional elements premounted in the shaft head, whereby valuable working time is saved on site.

The invention is suitable for use in elevators with charge. In order to provide additional safety for the maintenance staff for the work to be carried out on the elevator cage door on the side of the drive machine the connection of a elevator operation restrictor, as described by the Applicant in European patent application 97 119 575.5 can be advantageous. With a successful connection of the elevator restrictor electronic locking means for accessing the “forbidden” zone can be bridged by a low safety height, as by the elevator restriction it is ensured that the elevator cage does not reach its upper stop position. In addition, however even on accessing the blocked surface with a elevator restriction it can be ensured that an elevator cage sliding or moving from its standing position incorrectly can reach an elevator height endangering a person on the elevator cage roof.

We claim:

1. An elevator, in particular a traction sheave elevator, comprising a cage guided in a shaft, extending between a shaft head and a shaft pit, an elevator cage roof and a drive, operatively connected by at least one hauling cable to said elevator cage said drive is arranged at least partly in said shaft head above a first region of said elevator cage roof, and accessibility to said elevator cage roof is restricted to a second region.

2. An elevator according to claim 1, and wherein a prescribed safety area between said elevator cage roof and the ceiling of said shaft is ensured in said second region of said elevator cage roof.

3. An elevator according to claim 1, and wherein said drive includes a motor, at least one of a traction sheave or drum and at least one return pulley.

4. An elevator according to claim 1, and wherein said drive is mounted together with additional elevator components, including a cable end suspension and a speed restrictor disposed in a machine frame, supported by the shaft walls and guiding rails of at least one of said elevator or the ceiling of said shaft.

5. An elevator according to claim 1, and wherein said first region of said elevator cage roof can be blocked off by at least one of a mechanical safety device or electronic safety device.

6. An elevator according to claim 1, and wherein on said first region of said elevator cage, at least one of roof pressure mats, infrared radiation lattices or movement sensors are arranged, and activated upon entry to said first region to thereby prevent the operation or further operation of said elevator cage.

7. An elevator, in particular a traction sheave elevator comprising a cage guided in a shaft, extending between a shaft head and a shaft pit, an elevator cage roof and a drive mounted at least partly on a mount provided in the shaft and operatively connected by at least one hauling cable to said cage, said mount and the parts supported thereby of said drive are essentially arranged at the same height in said shaft.

8. An elevator according to claim 7, and wherein said mount in said shaft head is arranged above a first region of said cage roof, so that in a second region of said cage roof lying adjacent next to said first region, a safety distance above the left cage between the shaft cage roof and the elevator ceiling is provided, whereby said cage roof accessible and the accessibility is limited to said second region.

9. An elevator according to claim 8, and wherein said mount includes at least one of cable end suspensions speed restrictors and installation aids.

10. An elevator according to claim 7, and wherein said mount comprises a machine frame, disposed laterally about said drive.

11. An elevator according to claim 10, and wherein the housing of said drive functions as a machine frame.
